(19) United States
(12) Patent Application Publication
(10) Pub. No.: US 2005/0112441 A1
(43) Pub. Date: May 26, 2005

(54) Electroconductive curable resin composition, cured product thereof and process for producing the same

(76) Inventors: Tadashi Iino, Kanagawa (JP); Masayuki Noguchi, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/508,039

(22) PCT Filed: Mar. 20, 2003
(86) PCT No.: PCT/JP03/03471

Related U.S. Application Data
(60) Provisional application No. 60/367,218, filed on Mar. 26, 2002.

(30) Foreign Application Priority Data
Mar. 20, 2002 (JP) 2002-78114

(51) Int. Cl. H01M 8/02; H01B 1/24

(52) U.S. Cl. 429/34; 252/511

(57) ABSTRACT

An electroconductive curable resin composition comprising: (A) a curable resin and/or curable resin composition having a viscosity of from 0.1 to 1,000 Pa.s at 80° C. and from 0.01 to 100 Pa.s at 100° C.; and (B) a carbonaceous material at a ratio of 80 to 1:20 to 99 in terms of the mass ratio of component (A) to component (B). Such a resin composition is free from separation between a carbonaceous material and a resin at the mold working, excellent in the moldability (e.g., compression molding, transfer molding, injection molding, injection-compression molding) and capable of providing a cured product having high electroconductivity.

This Application claims the priority of an application based on U.S. Provisional Application Ser. No. 60/367218 (filed on Mar. 26, 2002).

### TECHNICAL FIELD

The present invention relates to a curable resin composition. More specifically, the present invention relates to an electroconductive curable resin composition having excellent electroconductivity, heat-radiating property and moldability, and also relates to a cured product thereof.

### BACKGROUND ART

Heretofore, metals, carbon materials and the like have been used in a field of application wherein a high electroconductivity is required. In particular, carbon materials are free from corrosion unlike metals and excellent in electroconductivity, heat resistance, lubricity, heat conductivity and durability. Therefore, carbon materials have played an important role in various fields such as electronics, electrochemistry, energy and transportation equipment. Also, composite materials based on a combination of a carbon material and a polymer material have made a remarkable progress and participated in achieving high performance and high function in various materials. Particularly, the degree of freedom of mold workability is expanded due to the combination of a carbon material and a polymer material, and this is one reason why carbon materials have grown in respective fields where the electroconductivity is required.

In view of environmental problems and energy problems, a fuel cell has attracted much attention as a clean power-generating device, because it generates power by a reverse reaction of electrolysis using hydrogen and oxygen, and produces no exhaust material other than water. Also in this field, carbon materials and polymer materials can act an important part. Among fuel cells, polymer electrolyte fuel cells work at a low temperature and therefore, they are most hopeful for automobile or public or civilian uses. This fuel cell is constructed by stacking unit cells, each of which comprises a polymer electrolyte, a gas diffusion electrode, a catalyst and a separator, and the fuel cell can attain high-output power generation.

The separator used here to separate unit cells has a groove or grooves to which a fuel gas and an oxidant gas are supplied. The separator is required to have high gas impermeability capable of perfectly separating these gases, and is also required to have high electroconductivity to reduce the internal resistance. Further, the separator is required to have excellent heat conductivity, durability and strength.

For the purpose of satisfying these requirements, the separator has been heretofore studied in view of both aspects of the metal and carbon materials. Metals have a problem in the corrosion resistance thereof and therefore, an attempt has been made to cover the surface thereof with a noble metal or carbon. However, in such a case, sufficiently high durability cannot be obtained and moreover, the cost for covering the metal is problematic.

On the other hand, a large number of carbon materials have been studied, and examples thereof include a molded article obtained by press-molding an expanded graphite sheet, a molded article obtained by impregnating a carbon sintered body with a resin and curing the resin, a vitreous carbon obtained by baking a thermosetting resin, and a molded article obtained by mixing a carbon powder and a resin and molding the resultant mixture.

For example, for solving the problem in reliability and dimensional precision, JP-A-8-222241 (the term “JP-A” as used herein means an “unexamined published Japanese patent application”) discloses a complicated process such that a binder is added to a carbon powder and mixed under heating, the mixture is CIP-molded, baked and graphitized, the thus obtained isotropic graphite material is impregnated with a thermosetting resin and subjected to a curing treatment, and grooves are engraved therein by cut working. JP-A-60-161144 discloses a technique of impregnating a paper containing carbon powder or carbon fiber with a thermosetting resin, stacking and press-bonding the resultant papers, and baking the stacked body.

JP-A-2001-68128 discloses a technique of injection-molding a phenol resin into a separator-shaped metal mold and baking the molded resin. Materials subjected to a baking treatment as in these examples exhibit high electroconductivity, but the baking takes a long time and the productivity is low. Further, when cut working is necessary, the mass productivity is low and the cost is high, and therefore, these materials can be hardly popularized in future.

A molding method is considered as means expected to bring high mass productivity and low cost. The material applicable thereto is generally a composite of a carbonaceous material and a resin. For example, JP-A-58-53167, JP-A-60-37670, JP-A-60-246568, JP-B-64-340 (the term “JP-B” as used herein means an “examined Japanese patent application”) and JP-B-6-22136 disclose a separator comprising graphite, carbon and a thermosetting resin such as phenol resin. JP-B-57-42157 discloses a bipolar separator comprising a thermosetting resin such as epoxy resin, and an electroconductive substance such as graphite, and JP-A-1-311570 discloses a separator obtained by blending an expanded graphite and a carbon black with a thermosetting resin such as phenol resin and furan resin.

In the composite of a carbonaceous material and a resin, the amount of the carbonaceous material filled in the material must be greatly increased for the purpose of obtaining a high electroconductivity. However, in such a case, the resin content is inevitably made larger so as to maintain the resultant moldability, and as a result, a sufficiently high electroconductivity cannot be obtained.

In order to enhance the moldability of the above composite material, a curable resin having a viscosity as low as possible is used. However, the carbonaceous material has no functional group on the surface (particularly when it is highly graphitized), and therefore, even if a surface treatment is applied thereto, the adhesion of the carbonaceous material to the resin scarcely increases. As a result, the resin and the carbonaceous material are separated from each other at the molding, and a uniform molded article cannot be obtained. As means for preventing the separation, PCT/US00/06999 discloses a method of increasing the viscosity of the resin by a thickener. However, only the addition of a thickener is insufficient for concurrently attaining higher electroconductivity and excellent moldability.

If the process of interest includes a baking step of heating the molded article at a high temperature of 1,000 to 3,000° C. for a long time is provided for obtaining high electroconductivity, there arise problems that the production takes a long time and the production process is complicated to cause an increase in the cost.

### DISCLOSURE OF INVENTION

An object of the present invention is to provide an electroconductive curable resin composition free from separation between a carbonaceous material and a resin at the mold working, excellent in the moldability (e.g., compression molding, transfer molding, injection molding, injection-compression molding) and capable of providing a cured product having high electroconductivity.

Another object of the present invention is to provide a separator for fuel cells, which can be obtained by molding the above-described composition and which has high electroconductivity and excellent heat-radiating property and costs low.

A further object of the present invention is to provide a process for producing such a separator for fuel cells.

As a result of earnest study, the present inventors have found that an electroconductive curable resin composition having excellent moldability and providing a cured product having high electroconductivity and excellent heat-radiating property can be obtained by using a curable resin and/or a curable resin composition having a specific viscosity property.

As a result of further study based on the above discovery, the present inventors have also found that by combining a specific carbon material containing boron with the above-described curable resin composition, an electroconductive cured product having high electroconductivity can be obtained, which is applicable to a separator for fuel cells, a collector for capacitors or various batteries, an electromagnetic wave-shielding plate, an electrode, a heat-radiating plate, a heat-radiating part, an electronic part, a semiconductor part, a bearing, a PTC device, a brush and the like. The present invention has been accomplished based on these findings.

More specifically, the present invention relates to the following matters.

[1] An electroconductive curable resin composition comprising:
(A) a curable resin and/or curable resin composition having a viscosity of from 0.1 to 1,000 Pa.s at 80° C. and from 0.01 to 100 Pa.s at 100° C.; and
(B) a carbonaceous material at a ratio of 80 to 1:20 to 99 in terms of the mass ratio of component (A) to component (B).

[2] The electroconductive curable resin composition according to [1], wherein the minimum viscosity of the component (A) on a curing curve in the range from 40 to 200° C. is from 0.01 to 100 Pa.s under the condition that the temperature rising rate is 20° C./min.

[3] The electroconductive curable resin composition according to [1] or [2], wherein the component (B) is one or more member selected from the group consisting of natural graphite, artificial graphite, expanded graphite, carbon black, carbon fiber, vapor grown carbon fiber and carbon nanotube.

[4] The electroconductive curable resin composition according to [3], wherein the component (B) is natural graphite, artificial graphite, vapor grown carbon fiber or carbon nanotube.

[5] The electroconductive curable resin composition according to any one of [1] to [4], wherein when a pressure is applied such that the bulk density of the carbonaceous material in the component (B) becomes 1 g/cm³, the powder electric resistivity of the component (B) in the direction right angled to the pressure direction is 0.1 Ω cm or less.

[6] The electroconductive curable resin composition according to any one of [1] to [5], wherein the carbonaceous material of the component (B) contains from 0.05 to 10 mass % of boron.

[7] An electroconductive cured product obtained by molding the electroconductive curable resin composition described in any one of [1] to [6], by using any one method selected from compression molding, transfer molding, injection molding and injection-compression molding.

[8] The electroconductive cured product according to [7], which has a volume resistivity of 2×10⁻² Ωcm or less.

[9] The electroconductive cured product according to [7] or [8, which has a contact resistance of 2×10⁻² Ωcm² or less.

[10] The electroconductive cured product according to any one of [7] to [9], which has a heat conductivity of 1.0 W/m.K or more.

[11] The electroconductive cured product according to any one of [7] to [10], which contains 0.1 ppm or more of boron.

[12] A process for producing an electroconductive cured product, comprising molding the electroconductive curable resin composition described in any one of [1] to [11], by any one method selected from compression molding, transfer molding, injection molding and injection-compression molding.

[13] The process for producing an electroconductive cured product according to [12], wherein the electroconductive curable resin composition is in the form of a pulverized product, a pellet or a sheet.

[14] The process for producing an electroconductive cured product according to [12] or [13], wherein the molding is performed while keeping the inside of metal mold or the metal mold as a whole in a vacuum state.

[15] The process for producing an electroconductive cured product according to any one of [12] to [14], wherein the injection-compression molding is any one selected from:
1) a method of injecting the composition in the state of the metal mold being opened and closing the metal mold,
2) a method of injecting the composition while closing the metal mold, and
3) a method of injecting the composition by setting the locking force of the closed metal mold to zero and then applying a locking force.

[16] The process for producing an electroconductive cured product according to [13], wherein the sheet is molded by any one method of extrusion molding, rolling, calendaring and compression molding and has a thickness of 0.5 to 5 mm and a width of 20 to 1,000 mm.

[17] A molded product comprising the electroconductive cured product described in any one of [1] to [11], in the form of any one selected from: a separator for fuel cells, a collector for capacitors or various batteries, an electromagnetic wave-shielding plate, an electrode, a heat-radiating plate, a heat-radiating part, an electronic part, a semiconductor part, a bearing, a PTC device and a brush.

[18] A separator for fuel cells, which has been manufactured by the process according to any one of [12] to [16].

[19] The separator for fuel cells according to [18], wherein the separator has four or more through holes, a groove having a width of 0.2 to 2 mm and a depth of 0.2 to 1.5 mm is formed on both surfaces of the separator, the thickness in the thinnest part is 1 mm or less, the specific gravity is 1.7 or more and the gas permeability is 1×10⁻⁶ cm²/sec or less.

### BRIEF DESCRIPTION OF DRAWINGS

FIG. 1 is a schematic view showing the method of measuring the electric resistivity of graphite powder.

FIG. 2 is a schematic view for explaining the method for calculating the electric resistivity of graphite powder.

FIG. 3 is a schematic view showing the method of measuring the contact resistance of cured product.

FIGS. 4(a) and 4(b) are schematic views for illustrating an example of the method of measuring the viscosity to be used in the present invention.

FIGS. 5(a) and 5(b) are schematic views for illustrating an example of the method of measuring the curing (or hardening) property to be used in the present invention.

In these figures, the respective Reference Numerals have the following meanings:
1: electrode (+)
1′: electrode (−)
2: compression rod
3: pedestal
4: side frame
5: sample
6: voltage probe
11: specimen
12: carbon plate
13: copper plate
14: probe

### BEST MODE FOR CARRYING OUT THE INVENTION

Hereinbelow, the present invention will be described in detail with reference to the accompanying drawings as desired. In the following description, “%” and “part(s)” representing a quantitative proportion or ratio are those based on mass, unless otherwise noted specifically.

(Curable Resin and/or Curable Resin Composition)

In the present invention, the curable resin and/or curable resin composition as the component (A) preferably has a viscosity of 0.1 to 1,000 Pa.s at 80° C. and a viscosity of 0.01 to 100 Pa.s at 100° C., more preferably a viscosity of 1 to 500 Pa.s at 80° C. and a viscosity of 0.01 to 50 Pa.s at 100° C., most preferably a viscosity of 1 to 100 Pa.s at 80° C. and a viscosity of 0.1 to 10 Pa.s at 100° C.

If the viscosity at 80° C. is less than 0.1 Pa.s and/or the viscosity at 100° C. is less than 0.01 Pa.s, the resin and the carbon-base filler may be separated at the mold working and molding failure is disadvantageously liable to occur. On the other hand, if the viscosity at 80° C. exceeds 1,000 Pa.s and/or the viscosity at 100° C. exceeds 100 Pa.s, the fluidity is bad due to high viscosity and particularly a product having a thin wall is hardly molded, and as a result, it becomes difficult to obtain a desired cured product.

In the present invention, the minimum viscosity of the component (A) on a curing curve in the range from 40 to 200° C. may preferably be from 0.01 to 100 Pa.s, more preferably from 0.01 to 50 Pa.s, most preferably from 0.1 to 10 Pa.s, under the condition that the temperature rising rate is 20° C./min. If the minimum viscosity on a curing curve in the range from 40 to 200° C. is less than 0.01 Pa.s under the condition that the temperature rising rate is 20° C./min, the resin and the carbon-base filler are separated at the molding due to excessively low viscosity and therefore, the viscosity in this range is not sufficient for the molding. On the other hand, if it exceeds 100 Pa.s, the fluidity is bad due to too high viscosity and therefore, this condition is not proper for molding.

The viscosity and curing property of the component (A) of the present invention are measured using Rheometer MCR300 manufactured by Physica. More specifically, the viscosity is measured by the static viscoelasticity measurement using a cone plate (CP25) under the condition that the gap is 0.5 mm, the distortion rate is 1 (1/S) and the measurement temperature is 80° C. and 100° C.

(Method of Measuring Viscosity)

FIGS. 4(a) and 4(b) are schematic views for illustrating an example of the method of measuring the viscosity to be used in the present invention with respect to these figures, the measurement conditions are as follows:
Measuring device: Rheometer MCR300, mfd. by Physica Co.
Measuring jig: cone-plate
Cone-plate diameter: 25 mm
Gap: 0.5 mm
Measurement temperature: 80° C., 100° C.
Shear rate (\dot{γ}): 1 (sec⁻¹ )

In this measurement, under a shear rate in a steady flow condition corresponding to a constant direction and a constant shear rate, and at a constant temperature, when the stress (torque) due to a sample shows a constant shear stress with respect to the elapse of time, the shear stress is measured. Then, the viscosity is calculated by using the thus obtained shear stress (τ) according to the following formula (1).
η=τ/\dot{γ} (1)

As for the curing property, the minimum viscosity on a curing curve is measured by the dynamic viscoelasticity measurement using a parallel plate (PP25) under the condition that the gap is 1 mm, the amplitude is 20%, the frequency is 10 Hz, the measurement temperature is from 40 to 200° C. and the temperature rising rate is 20° C./min.

(Method of Measuring Curing Property)

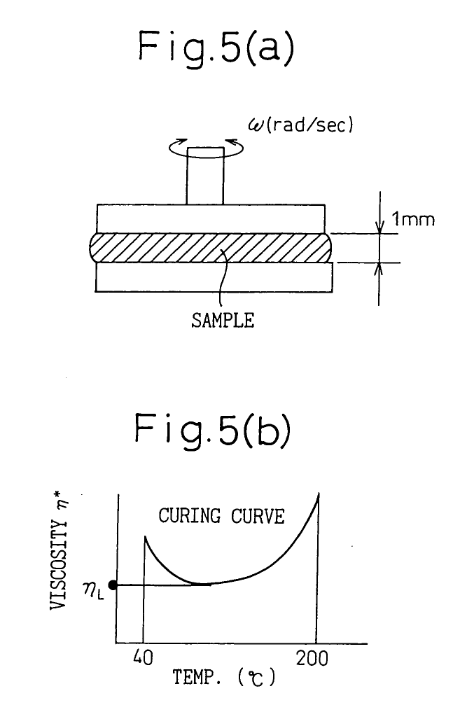

FIGS. 5(a) and 5(b) are schematic views for illustrating an example of the method of measuring the curing (or hardening) property to be used in the present invention. With respect to these figures, the measurement conditions are as follows:

Dynamic viscoelasticity measurement: A constant sine vibration is applied to a sample, and the maximum shear stress (G*) is measured, and the viscosity of the sample is calculated according to following formula (2).
Measuring device: Rheometer MCR300, mfd. by Physica Co.
Measuring jig: parallel-plate
Parallel-plate diameter: 25 mm
Gap: 1 mm
Measurement temperature: 40 to 200° C.
Temperature increasing rate: 20° C./min.
Amplitude: 20%
Frequency (f): 10 Hz (ω=2π×f)
   η*=G*/ω (2)

In this measurement, the temperature is changed from 40° C. to 200° C. at a temperature increasing rate of 20° C./min, and the resultant change in the viscosity of the sample is measured. Based on the thus obtained measurement results, the minimum viscosity (η_{L}) in the above temperature range is determined.

(Component (A))

Specific examples of the curable resin as the component (A) for use in the present invention may include phenolic resin, unsaturated polyester resin, epoxy resin, vinyl ester resin, alkyd resin, acrylic resin, melamine resin, xylene resin, guanamine resin, diallyl phthalate resin, allyl ester resin, furan resin, imide resin, urethane resin and urea resin.

Among these, at least one curable resin selected from phenolic resin, unsaturated polyester resin, epoxy resin, vinyl ester resin and allyl ester resin is preferred. In the field where heat resistance, acid resistance and the like are required, a resin having a cyclic structure such as homocyclic or heterocyclic structure in the molecular skeleton is more preferred.

When a resin having a cyclic structure in the molecular skeleton, such as a bisphenol-type unsaturated polyester or vinyl ester resin or a novolak-type vinyl ester, allyl ester or diallyl phthalate resin, is contained, the obtained electroconductive curable product can be advantageously improved in the heat resistance, chemical resistance and hydrothermal resistance. For uses where a long-term hydrothermal resistance is required, a curable resin having a molecular structure containing fluorine is most preferred.

In addition to the above-described curable resin, the curable resin composition as the component (A) may further contain at least one or more member (or additive) selected from a reactive monomer, a lubricant, a thickener, a crosslinking agent, a crosslinking aid, a curing initiator, a curing accelerator, a curing retardant, a plasticizer, a low shrinking agent, a thixotropic agent, a surfactant, a solvent and the like.

(Component (B))

The carbonaceous material as the component (B) for use in the present invention is not particularly limited as long as it is a carbonized material. In view of the provision of high electro-conductivity, it is preferred to use, for example, at least one or more material selected from the group consisting of natural graphite, artificial graphite, expanded graphite, carbon black, carbon fiber, vapor grown carbon fiber and carbon nanotube.

Among these, particularly preferred carbonaceous materials are natural graphite, artificial graphite, vapor grown carbon fiber and carbon nanotube.

The carbonaceous material as the component (B) for use in the present invention preferably has a powder electric resistivity as low as possible in the direction right angled to the pressure direction when the bulk density is 1 g/cm³. The powder electric resistivity may preferably be 0.1 Ωcm or less, more preferably 0.07 Ωcm or less. If the electric resistivity of the carbonaceous material as the component (B) exceeds 0.1 Ωcm, the cured product obtained by curing the composition is liable to decrease in the electroconductivity and a desired cured product may not be obtained.

(Method of Measuring the Electric Resistivity)

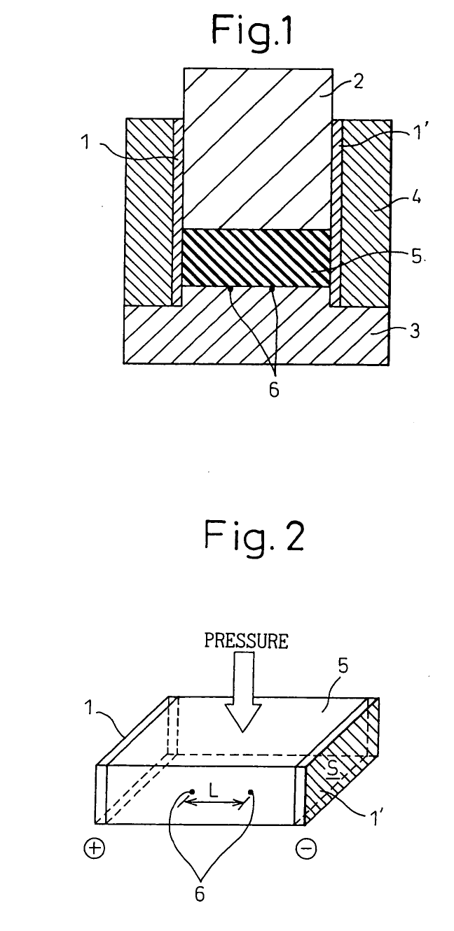

FIG. 1 shows a method of measuring the electric resistivity in the case of using a graphite powder which is one example of the carbonaceous material as the component (B) for use in the present invention. In FIG. 1, the reference numerals 1 and 1′ denote electrodes comprising a copper plate, the reference numeral 2 denotes a compression rod comprising a resin, the reference numeral 3 denotes a pedestal comprising a resin, the reference numeral 4 denotes a side frame comprising a resin, the reference numeral 5 denotes a sample graphite powder, and the reference numeral 6 denotes a voltage probe provided in the center part in the direction vertical to the sheet surface at the lower end of the sample.

Using this four-probe method shown in FIG. 1, the electric resistivity of a sample may be measured as follows. A sample is compressed by the compression rod 2. An electric current (I) is passed from the electrode 1 to the electrode 1′. The voltage (V) between probes is measured by the probe 6. At this time, a value when the sample is compressed to a bulk density of 1.5 g/cm³ by the compression rod is used for the voltage.

Assuming that the electric resistance (between probes) of the sample is R (Ω), R=V/I. From this, the electric resistivity can be determined according to ρ=R·S/L [ρ: electric resistivity, S: cross-sectional area (cm²) in the direction right angled to the current passing direction of the sample, namely, the pressure direction, L: distance between probes 6 (cm)]. In the actual measurement, the cross section of the sample in the right angle direction has a width of about 1 cm and a length (height) of 0.5 to 1 cm, the length in the current passing direction is 4 cm, and the distance (L) between probes is 1 cm.

(Artificial Graphite)

The case of using artificial graphite which is one example of the carbonaceous material as the component (B) for use in the present invention, is described. For obtaining artificial graphite, coke is generally first produced. The starting material of the coke is petroleum pitch, coal pitch or the like and this starting material is carbonized into coke. From the coke, graphite powder is generally obtained by, for example, a method of pulverizing and then graphitizing the coke, a method of graphitizing the coke itself and then pulverizing the graphitized coke, or a method of adding a binder to the coke, forming and baking the mixture, and graphitizing and then pulverizing the baked product (hereinafter, the coke and the baked product are collectively called “coke and the like”) into powder. The starting material coke and the like may preferably be hindered from the growth of crystal and preferably heat-treated at 2,000° C. or less, more preferably 1,200° C. or less.

The carbonaceous material (B) such as coke and natural graphite can be pulverized using a high-speed rotary mill (e.g., hammer mill, pin mill, cage mill), a ball mill (e.g., roll mill, vibrating mill, planetary mill) or a stirring mill (e.g., bead mill, attritor, flow tube-type mill, annular mill). In addition, a fine pulverizer such as screen mill, turbo mill, super micron mill and jet mill may also be used by selecting the conditions. The carbonaceous material (B) such as coke and natural graphite is pulverized using such a mill and by selecting the pulverization conditions and if desired, classifying the powder, the average particle size and the particle size distribution can be controlled.

The method for classifying the carbonaceous material (B) such as coke and natural graphite may be any method as long as the separation can be attained. For example, sieving or an air classifier such as forced vortex-type centrifugal classifier (e.g., micron separator, turboplex, turbo classifier, super separator) and inertial classifier (e.g., reformed virtual impactor, elbow jet) may be used. Also, a wet precipitation separation method, a centrifugal classification method or the like may be used.

(Graphite Powder Containing Boron)

In the present invention, for obtaining a natural graphite powder or artificial graphite powder having high electroconductivity, B in elemental form, H₃BO₃, B₂O₃, B₄C, BN or the like is added as a boron source to the powder before the graphitization treatment and thoroughly mixed and then the mixture is graphitized. If the mixing of the boron compound is not uniform, the graphite powder is not only non-uniform but also highly probably sintered at the graphitization. For attaining uniform mixing of the boron compound, the boron source may preferably be mixed after forming it into powder having a particle size of 50 μm or less, preferably about 20 μm or less.

The temperature at the time of graphitizing the powder containing the boron source may preferably be higher, but due to restriction by the apparatus and the like, the graphitization temperature may preferably be in the range from 2,500° C. to 3,200° C. The graphitization method is not particularly limited but the graphitization may be performed by, for example, a method of using an Acheson furnace where the powder is enclosed in a graphite crucible and an electric current is directly passed therethrough, or a method of heating the powder by means of a graphite heating element.

(Expanded Graphite Powder)

The expanded graphite powder to be used as the carbonaceous material (B) in the present invention may be, for example, a powder obtained by a method where a graphite having a highly grown crystal structure such as natural graphite and pyrolytic graphite is dipped in a strongly oxidative solution such as a mixed solution of concentrated sulfuric acid and nitric acid or a mixed solution of concentrated sulfuric acid and aqueous hydrogen peroxide to produce a graphite intercalation compound and the graphite intercalation compound produced is washed with water and rapidly heated to expand the graphite crystal in the C-axis direction, or a powder obtained by once rolling the powder obtained above into a sheet and then pulverizing the sheet.

(Carbon Fiber)

Specific examples of the carbon fiber to be used as the carbonaceous material (B) include a pitch-type carbon fiber obtained from heavy oil, by-product oil or coal tar, and a PAN-type carbon fiber obtained from polyacrylonitrile.

The vapor grown carbon fiber to be used as the carbonaceous material (B) is obtained, for example, by causing a thermal decomposition reaction using a starting material organic compound such as benzene, toluene or natural gas together with a hydrogen gas at from 800 to 1,300° C. in the presence of a transition metal catalyst such as ferrocene. The obtained vapor growth carbon fiber may preferably be further subjected to a graphitization treatment at about 2,500 to 3,200° C., more preferably a graphitization treatment together with a graphitization catalyst such as boron, boron carbide, beryllium, aluminum or silicon at about 2,500 to 3,200° C.

The vapor grown carbon fiber for use in the present invention preferably has a fiber diameter of 0.05 to 10 μm and a fiber length of 1 to 500 μm. The fiber diameter is more preferably from 0.1 to 5 μm, most preferably from 0.1 to 0.5 μm, and the fiber length is more preferably from 5 to 100 μm, most preferably from 10 to 20 μm.

(Carbon Nanotube)

The carbon nanotube to be used as the carbonaceous material (B) is recently taken notice of in industry not only by its mechanical strength but also by its field emission function and hydrogen absorption function and furthermore, by its magnetic function. This carbon nanotube is also called graphite whisker, filamentous carbon, graphite fiber, extra fine carbon tube, carbon tube, carbon fibril, carbon microtube or carbon nanofiber.

The carbon nanotube includes a single layer carbon nanotube where a graphite film forming the tube is a single layer, and a multilayer carbon nanotube where the graphite film is composed of multiple layers. In the present invention, either may be used but a single carbon nanotube is preferred because a cured product having higher electroconductivity or mechanical strength can be obtained.

The carbon nanotube is manufactured, for example, by an arc discharge method, a laser evaporation method or a thermal decomposition method, which are described in Carbon Nanotube no Kiso (Elementary Study of Carbon Nanotube), pages 23 to 57, Corona Sha (1998). For elevating the purity, the carbon nanotube obtained is further purified by a hydrothermal method, a centrifugal separation method, an ultrafiltration method, an oxidation method or the like.

For removing impurities, the carbon nanotube may preferably be subjected to a high-temperature treatment in an inert gas atmosphere at about 2,500 to 3,200° C., more preferably a high-temperature treatment at about 2,500 to 3,200° C. in an inert gas atmosphere together with a graphitization catalyst such as boron, boron carbide, beryllium, aluminum and silicon.

The carbon nanotube for use in the present invention preferably has a fiber diameter of 0.5 to 100 nm and a fiber length of 0.01 to 10 μm. The fiber diameter is more preferably from 1 to 10 nm, still more preferably from 1 to 5 nm, and the fiber length is more preferably from 0.05 to 5 μm, still more preferably from 0.1 to 3 μm.

The fiber diameter and fiber length of the vapor grown carbon fiber and carbon nanotube for use in the present invention can be measured using an electron microscope.

More specifically, in this measurement, the diameters and lengths of 100 pieces of fibers are measured, the number-average values of these diameters and lengths are calculated.

(Carbon Black)

Specific examples of the carbon black for use in the present invention may include Ketjen black and acetylene black which are obtained by the incomplete combustion of a natural gas and the like or by the thermal decomposition of acetylene, a furnace carbon obtained by the incomplete combustion of a hydrocarbon oil or a natural gas, and a thermal carbon obtained by the thermal decomposition of a natural gas.

(Boron Content)

The amount of boron contained in the carbonaceous material as the component (B) of the present invention may preferably be from 0.05 to 10 mass %. If the amount of boron is less than 0.05 mass %, the objective graphite powder having high electroconductivity may not be obtained. Even if the amount of boron exceeds 10 mass %, the effect of improving the electroconductivity of the carbon material is small.

Into the carbonaceous material as the component (B), the boron can be incorporated, for example, by a method of adding a boron source such as B in elemental form, B₄C, BN, B₂O₃ or H₃BO₃ to a single substance of natural graphite, artificial graphite, expanded graphite, carbon black, carbon fiber, vapor grown carbon fiber, carbon nanotube or the like or a mixture of one or more thereof, thoroughly mixing the boron compound, and then graphitizing the mixture at about 2,500 to 3,200° C.

If the mixing of boron compound is not uniform, the resulting graphite powder is not only non-uniform but also highly probably sintered at the graphitization. For attaining uniform mixing, the boron source may preferably be formed into powder having a particle size of 50 μm or less, preferably about 20 μm or less and then mixed with the powder of coke or the like.

If the carbonaceous material as the component (B) does not contain boron and is graphitized, the graphitization degree (i.e., crystallinity) decreases and the lattice spacing increases. As a result, a graphite powder having high electroconductivity ie less liable to be obtained. The form of boron contained is not particularly limited as long as boron and/or a boron compound is mixed in the graphite, but in a preferred form, boron is present between layers of graphite crystal or a boron atom is substituted to a part of carbon atoms constituting the graphite crystal. In the case where a part of carbon atoms is substituted by a boron atom, the bonding between the boron atom and the carbon atom may be in any bonding form such as covalent bonding or ionic bonding.

(Ratio of Curable Resin and/or Resin Composition)

The ratio of the curable resin and/or curable resin composition as the component (A) and the carbonaceous material as the component (B) of the present invention may preferably be 80 to 1:20 to 99 in terms of the mass ratio. If the amount of the component (A) added exceeds 80 mass % and the amount of the carbon material (B) added is less than 20 mass %, the cured product is reduced in the electroconductivity and this is not preferred.

The above-mentioned viscosity values (i.e., viscosity of from 0.1 to 1,000 Pa.s at 80° C. and from 0.01 to 100 Pa.s at 100° C.) for defining the component (A) constituting the electroconductive curable resin composition according to the present invention is the value thereof before the addition of the above additive. In the present invention, it is possible to add the additive(s) in an extent wherein the moldablity of the electroconductive curable resin composition is not substantially impared.

(Additive)

For the purpose of improving hardness, strength, electroconductivity, moldability, durability, weather resistance, water resistance and the like, the electroconductive curable resin composition of the present invention may further contain additives such as a glass fiber, an organic fiber, an ultraviolet stabilizer, an antioxidant, a defoaming agent, a leveling agent, a mold releasing agent, a lubricant, a water repellent, a thickener, a low shrinking agent and a hydrophilicity-imparting agent.

(Preparation of Resin Composition)

For obtaining the electroconductive curable resin composition of the present invention, the above-described components may preferably be mixed uniformly while constantly keeping a temperature of not causing the initiation of curing by using a mixer or kneader commonly used in the field of resin, such as roll, extruder, kneader, Banbury mixer, Henschel mixer or planetary mixer. In the case of adding an organic peroxide, the organic peroxide may preferably be added and mixed at the final stage after all other components are uniformly mixed.

For the purpose of facilitating the supply of the materials to a molding machine or a metal mold, the electroconductive curable composition of the present invention can be pulverized or granulated after kneading or mixing.

The electroconductive curable composition can be pulverized using a homogenizer, a Wiley mill, a high-speed rotary mill (e.g., hammer mill, pin mill, cage mill, blender) or the like. The pulverization may preferably be performed while cooling so as to prevent the materials from aggregating with each other. The granulation may be performed by a method of pelletizing the electroconductive curable composition using an extruder, a kneader or a co-kneader, or by the use of a pan-type granulator.

(Molding of Curable Composition)

For molding the electroconductive curable composition of the present invention, compression molding, transfer molding, injection molding, injection-compression molding or the like is used. The molding may preferably be performed while keeping the inside of metal mold or the metal mold as a whole in a vacuum state at various mold workings.

In the compression molding, for elevating the molding cycle, a multi-cavity mold may preferably be used. A multistage press (laminate press) method is more preferred, because a large number of products can be molded by a small output. In the case of a flat product, the compression molding may preferably be performed after once forming a non-cured sheet, so as to elevate the plane precision.

In the injection molding, for the purpose of further elevating the moldability, the molding can be performed in a supercritical state by injecting a carbon dioxide gas from the halfway point of the molding machine cylinder and dissolving the gas in the materials. For elevating the plane precision of a product, an injection-compression method is preferred.

The injection-compression molding method which can be used includes 1) a method of injecting the materials in the state of the metal mold being closed and the locking force being set to zero, 2) a method of injecting the materials in the state of the metal mold being opened to a predetermined position and then closing the metal mold and 3) a method of injecting the materials in the state of the metal mold being opened and while injecting the materials, closing the metal mold.

With respect to the metal mold temperature, it is important to select and find an optimum temperature according to the kind of the composition. The temperature may be appropriately selected according to the kind of the materials, but for example, a temperature of 120 to 200° C. for 30 to 1,200 seconds may be selected. In particular, when a radical reactive curable resin, epoxy resin, phenol resin or the like is used, a temperature of 150 to 180° C. for 30 to 120 seconds is preferred. After the composition is cured, after-curing is applied at a temperature of 150 to 200° C. for 10 to 600 minutes, whereby complete curing can be achieved. By performing the after-curing under pressure of 5 MPa or more, the product can be prevented from warping.

(Cured Product)

The electroconductive cured product of the present invention preferably has the following properties. That is, the volume resistivity may preferably be 2×10⁻² Ωcm or less, more preferably 8×10⁻³ Ωcm or less. Particularly, in the case of use in a separator for fuel cells, a collector for capacitors or various batteries, an electromagnetic wave-shielding plate, an electrode, a heat-radiating plate, a heat-radiating part, an electronic part, a semiconductor part, a bearing, a PTC device or a brush, the volume resistivity is suitably 5×10⁻³ Ωcm or less.

The contact resistance may preferably be 2×10⁻² Ωcm² or less, more preferably 1×10⁻² Ωcm² or less, still more preferably 7×10⁻³ Ωcm² or less. The heat conductivity may preferably be 1.0 W/m.K or more, more preferably 4.0 W/m.K or more, still more preferably 10 W/m.K or more.

The electroconductive cured product of the present invention preferably contains 0.1 ppm or more of boron. The boron content is more preferably 0.5 ppm or more, still more preferably 1 ppm or more. If the boron content less than 0.1 ppm, a high electroconductivity cannot be obtained.

The specific gravity of the separator for fuel cells of the present invention is measured in accordance with JIS K7112, Method A (underwater substitution method). The gas permeability is measured using helium gas at 23° C. in accordance with JIS K7126, Method A.

The electroconductive curable resin composition of the present invention is facilitated in the molding and therefore, is optimal as a composite material in the fields where the thickness precision is required, such as separator for fuel cells. Further, the cured product thereof can reproduce the electroconductivity or heat conductivity of the graphite without limit and can have very high performance by exhibiting excellent properties in the heat resistance, corrosion resistance, molding precision and the like.

Accordingly, the cured product of the present invention is useful for uses such as various parts in the electronic field, electric parts, machine parts and vehicle parts. In particular, the cured product of the present invention is suitably used as a material of a collector for capacitors or various batteries, an electromagnetic wave-shielding plate, an electrode, a heat-radiating plate, a heat-radiating part, an electronic part, a semiconductor part, a bearing, a PTC device, a brush or a separator for fuel cells.

### EXAMPLES

The present invention is described in more detail below by referring to Examples, but the present invention is by no means limited to these Examples.

The materials used are shown in Table 1.

TABLE 1
Component (A) (curable resin and/or curable resin
composition)

| | | A1 | A2 | A3 | A4 | A5 |
|---|---|---|---|---|---|---|
| Allyl ester resin | AC 701 | 70 | | | | |
| (produced by Showa | | | | | | |
| Denko K.K.) | | | | | | |
| Allyl ester resin | AP 001 | | 100 | 70 | | |
| (produced by Showa | | | | | | |
| Denko K.K.) | | | | | | |
| Unsaturated | YUPIKA | 30 | | 30 | | 100 |
| polyester resin | 8524 | | | | | |
| (produced by Nihon | | | | | | |
| Yupika K.K.) | | | | | | |
| Vinyl ester resin | H-600 | | | | 100 | |
| (produced by Showa | | | | | | |
| Kobunshi K.K.) | | | | | | |
| Dicumyl peroxide | PERCUMYLD | 2 | 2 | 2 | 2 | 2 |
| (produced by NOF | | | | | | |
| Corporation) | | | | | | |
| Reagent (produced | stearic | 2 | 2 | 2 | 2 | 2 |
| by Junsei Kagaku K.K.) | acid | | | | | |
| Reagent (produced | zinc | 3 | 3 | 3 | 3 | 3 |
| by Junsei Kagaku K.K.) | stearate | | | | | |
| Viscosity (Pa·s) | 80° C. | 20.4 | 11.2 | 203 | 0.067 | 11900 |
| | 100° C. | 3.74 | 1.76 | 12.4 | 0.027 | 620 |

| | | | | | |
|---|---|---|---|---|---|
| Minimum viscosity on curing | 1.21 | 0.81 | 4.96 | 0.0098 | 186 |
| curve (40 to 200° C.) | | | | | |

The viscosity and curing property of the curable resin and/or the curable resin composition were measured using Rheometer MCR300 manufactured by Physica.

The viscosity was measured by the static viscoelasticity measurement using a cone plate (CP25) under the condition that the gap was 0.5 mm, the distortion rate was 1 (1/S) and the measurement temperature was 80° C. and 100° C.

As for the curing property, the minimum viscosity on a curing curve was measured by the dynamic viscoelasticity measurement using a parallel plate (PP25) under the condition that the gap was 1 mm, the amplitude was 20%, the frequency was 10 Hz, the measurement temperature was from 40 to 200° C. and the temperature rising rate was 20° C./min.

Component (B) (Carbonaceous Material)

B1:

LPC-S Coke produced by Shin Nittetsu Kagaku K.K., which is a non-acicular coke (calcined product), was coarsely pulverized into a size of 2 to 3 mm by a pulverizer [manufactured by Hosokawa Micron K.K.]. This coarsely pulverized product was finely pulverized by a jet mill (IDS2UR, manufactured by Nippon Pneumatic K.K.). Thereafter, the powder obtained was adjusted to the desired particle size by the classification. The particles of 5 μm or less were removed by air classification using a turbo classifier (TC15N, manufactured by Nisshin Engineering K.K.).

To a part (14.4 kg) of this finely pulverized product, 0.6 kg of boron carbide (B₄C) was added and then mixed by a Henschel mixer at 800 rpm for 5 minutes. The resulting mixture was enclosed in a graphite crucible with a cover having an inside diameter of 40 cm and a volume of 40 liter. The crucible was sealed and placed in a graphitization furnace using a graphite heater and the powder was graphitized at a temperature of 2,900° C. in an argon atmosphere. After allowing to cool, the powder was taken out to obtain 14 kg of powder. The obtained graphite fine powder had an average particle size of 20.5 μm and a B content of 1.3 wt %.

B2:

LPC-S Coke (hereinafter refers to as “Coke A”) produced by Shin Nittetsu Kagaku K.K., which is a non-acicular coke (calcined product), was coarsely pulverized into a size of 2 to 3 mm by a pulverizer [manufactured by Hosokawa Micron K.K.]. This coarsely pulverized product was finely pulverized by a jet mill (IDS2UR, manufactured by Nippon Pneumatic K.K.). Thereafter, the powder obtained was adjusted to the desired particle size by the classification. The particles of 5 μm or less were removed by air classification using a turbo classifier (TC15N, manufactured by Nisshin Engineering K.K.).

To a part (14.2 kg) of this finely pulverized product, 0.2 kg of vapor grown carbon fiber (VGCF-G (“VGCF” is a registered trademark of Showa Denko K.K.), produced by Showa Denko K.K., fiber diameter: 0.1 to 0.3 μm, fiber length: 10 to 50 μm) and 0.6 kg of boron carbide (B₄C) were mixed by a Henschel mixer at 800 rpm for 5 minutes. The resulting mixture was enclosed in a graphite crucible with a cover having an inside diameter of 40 cm and a volume of 40 liter. The crucible was sealed and placed in a graphitization furnace using a graphite heater and the powder was graphitized at a temperature of 2,900° C. in an argon atmosphere. After allowing to cool, the powder was taken out to obtain 14.1 kg of powder. The obtained graphite fine powder had an average particle size of 19.5 μAm and a B content of 1 wt %.

B3:

14.85 kg of artificial graphite (UFG30) (“UFG” is a registered trademark of Showa Denko K.K.) produced by Showa Denko K.K. and 0.15 kg of boron carbide (B₄C) were mixed by a Henschel mixer at 800 rpm for 5 minutes. The resulting mixture was enclosed in a graphite crucible with a cover having an inside diameter of 40 cm and a volume of 40 liter. The crucible was sealed and placed in a graphitization furnace using a graphite heater and the powder was graphitized at a temperature of 2,900° C. in an argon atmosphere. After allowing to cool, the powder was taken out to obtain 14.4 kg of powder. The obtained graphite fine powder had an average particle size of 12.1 μm and a B content of 0.2 wt %.

B4:

14.85 kg of natural graphite (LB-CG) produced by Nihon Kokuen Kogyo and 0.15 kg of boron carbide (B₄C) were mixed by a Henschel mixer at 800 rpm for 5 minutes. The resulting mixture was enclosed in a graphite crucible with a cover having an inside diameter of 40 cm and a volume of 40 liter. The crucible was sealed and placed in a graphitization furnace using a graphite heater and the powder was graphitized at a temperature of 2,900° C. in an argon atmosphere. After allowing to cool, the powder was taken out to obtain 13.9 kg of powder. The obtained graphite fine powder had an average particle size of 20.6 μm and a B content of 0.1 wt %.

B5:

Coke A was coarsely pulverized by a pulverizer into a size of 2 to 3 mm and this coarsely pulverized product was finely pulverized by a jet mill. Thereafter, the powder obtained was adjusted to the desired particle size by the classification. The particles of 5 μm or less were removed by air classification using a turbo classifier. Then, the powder was enclosed in a graphite crucible with a cover having an inside diameter of 40 cm and a volume of 40 liter. The crucible was sealed and placed in a graphitization furnace using a graphite heater and the powder was graphitized at a temperature of 2,900° C. After allowing to cool, the powder was taken out to obtain a graphite fine powder. The obtained graphite fine powder had an average particle size of 20.5 μm and a B content of 0 wt %.

The methods for measuring the physical properties of the cured product are described below.

The volume resistivity was measured by the four-point probe array in accordance with JIS K7194.

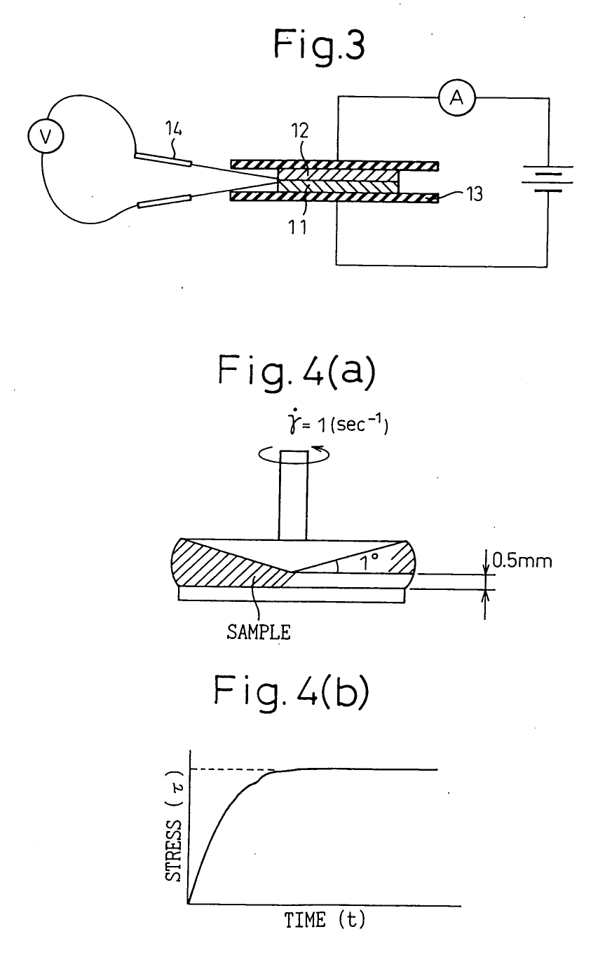

The contact resistance value was determined as follows. A specimen 11 (20mm×20 mm×2 mm) and a carbon paper 12 (TGP-H-60, produced by Toray Industries, Inc.) (20 mm×20 mm×0.1 mm) were contacted in an apparatus shown in FIG. 3 and then sandwiched by copper plates 13 and a plane pressure of 1.96 MPa was applied thereon. A constant current of 1 A was passed in the through direction and probes 14 were contacted to the interface between the specimen 11 and the carbon paper 12 to measure the voltage. From the voltage measured, the resistance value was calculated. The value obtained was integrated with the contacting cross-sectional area and the resulting value was designated as the contact resistant value.

The flexural strength and the flexural modulus were measured using a specimen ** at span intervals of 64 mm and at a bending rate of 2 mm/min by the three-point system flexural strength measuring method in accordance with JIS K6911. The sample size was 100×10×1.5 mm.

In Examples 1 to 7 and Comparative Examples 1 to 2, the components were kneaded for 5 minutes at a temperature of 70° C. and a rotation number of 40 rpm using a pressure-type kneader (1 L). The composition was adjusted to be filled in 80 wt %. After kneading, the kneaded product was charged into a metal mold capable of forming a plate of 100×100×1.5 mm and cured for 5 minutes at a metal mold temperature of 170° C. under pressure of 30 MPa using a 50 t compression molding machine to obtain a cured product.

Further, in Examples 1 to 3 and Comparative Examples 1 to 2, the separator plate having a size of 120×100×1.5 mm and having on the both surfaces thereof a meandered groove with a pitch of 1 mm and a groove depth of 0.5 mm was subjected to an injection molding test at a metal mold temperature of 160° C. using a 75 t injection molding machine.

The difference of moldability due to difference in the viscosity of thermosetting resin composition is shown in Table 2.

TABLE 2

| | | | | | Comparative | |
|---|---|---|---|---|---|---|
| | | Example | | | Example | |
| | | 1 | 2 | 3 | 1 | 2 |
| Curable resin | A1 | 100 | | | | |
| composition | | | | | | |
| | A2 | | 100 | | | |
| | A3 | | | 100 | | |
| | A4 | | | | 100 | |
| | A5 | | | | | 100 |
| Carbonaceous | B1 | 400 | 400 | 400 | 400 | 400 |
| material | | | | | | |
| Volume resistivity | mΩcm | 4.1 | 3.2 | 5.4 | 3.6 | 15 |
| Contact resistance | mΩcm² | 5.2 | 3.6 | 6 | 10 | 63 |
| Heat conductivity | W/mk | 20 | 16 | 14 | 18 | 12 |
| Flexural strength | MPa | 66 | 56 | 57 | 21 | 49 |
| Flexural modulus | GPa | 17 | 16 | 21 | 12 | 19 |

| | | | | | |
|---|---|---|---|---|---|
| Moldability (disc flow | ◯ | ◯ | ◯ | X(1) | X(2) |
| test)^{*1} | | | | | |
| Injection molding test^{*2} | ◯ | ◯ | ◯ | X | X |

*1 Disc flow test: When 10 g of composition was charged into a press machine adjusted to 160° C. and a load of 18 t was applied, the spreading (diameter) or appearance of the materials was evaluated.
◯: The materials were not separated and the spreading (diameter) of the materials was 110 mm or more.
X: The materials were separated and the spreading (diameter) of the materials was less than 110 mm.
X(1): The carbonaceous material and the curable resin were separated.
X(2): Insufficient fluidity. The disc flow was 80 mm.
*2 ◯: A separator-shaped product having on both surfaces thereof a groove and free from molding failure can be obtained.
X: A separator-shaped product cannot be obtained due to molding failure. When the viscosity was low to cause separation of the carbonaceous material and the thermosetting resin composition, only the resin flowed while allowing the filler to remain at the mold working and therefore, the injection molding could not be performed. Also, when the viscosity was excessively high, the injection molding could not be performed due to bad fluidity and high curing rate.

In Table 3, it is shown that when a carbonaceous material containing boron is used, a cured product having high electroconductivity is obtained.

TABLE 3

| | | Example | | | |
|---|---|---|---|---|---|
| | | 4 | 5 | 6 | 7 |
| Curable resin | A1 | 100 | 100 | 100 | 100 |
| composition | | | | | |
| Carbonaceous | B2 | 400 | | | |
| material | B3 | | 400 | | |
| | B4 | | | 400 | |
| | B5 | | | | 400 |
| Volume resistivity | mΩcm | 4 | 3.5 | 4 | 12 |
| Contact resistance | mΩcm² | 4.8 | 3.8 | 4 | 18 |
| Heat conductivity | W/mk | 18 | 25 | 20 | 16 |
| Flexural strength | MPa | 62 | 61 | 64 | 58 |
| Flexural modulus | GPa | 19 | 37 | 44 | 18 |

Industrial Applicability

The electroconductive curable resin composition of the present invention can provide a cured product having excellent electroconductivity and heat-radiating property and therefore, can be widely applied to the materials which cannot be heretofore realized, for example, various uses and parts such as product in the electronic field, electric product, machine parts and vehicle parts. In particular, the electroconductive curable resin composition of the present invention is useful as a raw material for use in a collector for capacitors or various batteries, an electromagnetic wave-shielding plate, an electrode, a heat-radiating plate, a heat-radiating part, an electronic part, a semiconductor part, a bearing, a PTC device, a brush or a separator for fuel cells such as polymer electrolyte fuel cells.

1. An electroconductive curable resin composition comprising:
(A) a curable resin and/or curable resin composition having a viscosity of from 0.1 to 1,000 Pa.s at 80° C. and from 0.01 to 100 Pa.s at 100° C.; and
(B) a carbonaceous material at a ratio of 80 to 1:20 to 99 in terms of the mass ratio of component (A) to component (B).

2. The electroconductive curable resin composition according to claim 1, wherein the minimum viscosity of the component (A) on a curing curve in the range from 40 to 200° C. is from 0.01 to 100 Pa.s under the condition that the temperature rising rate is 20° C./min.

3. The electroconductive curable resin composition according to claim 1 or 2, wherein the component (B) is one or more member selected from the group consisting of natural graphite, artificial graphite, expanded graphite, carbon black, carbon fiber, vapor grown carbon fiber and carbon nanotube.

4. The electroconductive curable resin composition according to claim 3, wherein the component (B) is natural graphite, artificial graphite, vapor grown carbon fiber or carbon nanotube.

5. The electroconductive curable resin composition according to any one of claims 1 to 4, wherein when a pressure is applied such that the bulk density of the carbonaceous material in the component (B) becomes 1 g/cm³, the powder electric resistivity of the component (B) in the direction right angled to the pressure direction is 0.1 Ωcm or less.

6. The electroconductive curable resin composition according to any one of claims 1 to 5, wherein the carbonaceous material of the component (B) contains from 0.05 to 10 mass % of boron.

7. An electroconductive cured product obtained by molding the electroconductive curable resin composition described in any one of claims 1 to 6, by using any one method selected from compression molding, transfer molding, injection molding and injection-compression molding.

8. The electroconductive cured product according to claim 7, which has a volume resistivity of 2×10⁻² Ωcm or less.

9. The electroconductive cured product according to claim 7 or 8, which has a contact resistance of 2×10⁻² Ωcm² or less.

10. The electroconductive cured product according to any one of claims 7 to 9, which has a heat conductivity of 1.0 W/m.K or more.

11. The electroconductive cured product according to any one of claims 7 to 10, which contains 0.1 ppm or more of boron.

12. A process for producing an electroconductive cured product, comprising molding the electroconductive curable resin composition described in any one of claims 1 to 11, by any one method selected from compression molding, transfer molding, injection molding and injection-compression molding.

13. The process for producing an electroconductive cured product according to claim 12, wherein the electroconductive curable resin composition is in the form of a pulverized product, a pellet or a sheet.

14. The process for producing an electroconductive cured product according to claim 12 or 13, wherein the molding is performed while keeping the inside of metal mold or the metal mold as a whole in a vacuum state.

15. The process for producing an electroconductive cured product according to any one of claims 12 to 14, wherein the injection-compression molding is any one selected from:
1) a method of injecting the composition in the state of the metal mold being opened and closing the metal mold,
2) a method of injecting the composition while closing the metal mold, and
3) a method of injecting the composition by setting the locking force of the closed metal mold to zero and then applying a locking force.

16. The process for producing an electroconductive cured product according to claim 13, wherein the sheet is molded by any one method of extrusion molding, rolling, calendaring and compression molding and has a thickness of 0.5 to 5 mm and a width of 20 to 1,000 mm.

17. A molded product comprising the electroconductive cured product described in any one of claims 1 to 11, in the form of any one selected from: a separator for fuel cells, a collector for capacitors or various batteries, an electromagnetic wave-shielding plate, an electrode, a heat-radiating plate, a heat-radiating part, an electronic part, a semiconductor part, a bearing, a PTC device and a brush.

18. A separator for fuel cells, which has been manufactured by the process according to any one of claims 12 to 16.

19. The separator for fuel cells according to claim 18, wherein the separator has four or more through holes, a groove having a width of 0.2 to 2 mm and a depth of 0.2 to 1.5 mm is formed on both surfaces of the separator, the thickness in the thinnest part is 1 mm or less, the specific gravity is 1.7 or more and the gas permeability is 1×10⁻⁶ cm²/sec or less.
